(19) United States
(12) Patent Application Publication
(10) Pub. No.: US 2011/0116195 A1
(43) Pub. Date: May 19, 2011

(54) MAGNETIC WRITE HEAD DESIGN USING PERMANENT MAGNETS AND EXCHANGE SPRING MECHANISM

(75) Inventors: Alexandru Cazacu, Derry (GB); Mark Anthony Gubbins, Letterkenny (IE)

(73) Assignee: SEAGATE TECHNOLOGY LLC, Scotts Valley, CA (US)

(21) Appl. No.: 12/621,767

(22) Filed: Nov. 19, 2009

(51) Int. Cl. G11B 5/33

(52) U.S. Cl. 360/319; G9B/5.104

(57) ABSTRACT

A magnetic recording head includes a write pole and a first permanent magnet. The write pole has a write pole tip, a leading edge, a trailing edge, a first side and a second side. The first permanent magnet is located either at the trailing edge of the write pole, the first side of the write pole or at the second side of the write pole. The first permanent magnet has a magnetization orientation that is changed in relation to a field of the write pole.

### SUMMARY

A magnetic recording head includes a write pole and a first permanent magnet. The write pole has a write pole tip, a leading edge, a trailing edge, a first side and a second side. The first permanent magnet is located either at the trailing edge of the write pole, the first side of the write pole or at the second side of the write pole. The first permanent magnet has a magnetization orientation that is changed in relation to a field of the write pole.

### BRIEF DESCRIPTION OF THE DRAWINGS

FIG. 1 is a cross-sectional view of a recording head having a first write gap and a synthesized low magnetization shield taken substantially normal to a magnetic medium.

FIG. 2A is a cross-sectional view of a writer containing a permanent magnet stack in a write pole body when a write field of the write pole is zero.

FIG. 2B and FIG. 2C are cross-sectional views of the writer of FIG. 2A when the write field of the write pole is positive and negative, respectively.

FIG. 3A is a cross-sectional view of a writer containing a write pole and a permanent magnet in a side shield.

FIG. 3B, FIG. 3C and FIG. 3D are enlarged medium facing surface views of the writer of FIG. 3A when the write field of a write pole is zero, positive and negative, respectively.

FIG. 4A is an enlarged medium facing surface view of a writer containing a write pole and a down-track oriented two-layer permanent magnet stack in a side shield, when a write field of the write pole is zero.

FIG. 4B and FIG. 4C are enlarged medium facing surface views of the writer of FIG. 4A when the write field of the write pole is positive and negative, respectively.

FIG. 5A is a cross-sectional view of a writer containing a write pole and a cross-track oriented two-layer permanent magnet stack in a side shield, when a write field of the write pole is zero.

FIG. 5B is an enlarged medium facing surface view of the writer of FIG. 5A.

FIG. 6A is a cross-sectional view of a writer containing a write pole and a cross-track oriented three-layer permanent magnet stack in a side shield when a write field of the write pole is zero.

FIG. 6B is an enlarged medium facing surface view of the writer of FIG. 6A.

FIG. 7A is an enlarged medium facing surface view of a writer containing a write pole and asymmetric permanent magnets in side shields when a write field of the write pole is zero.

FIG. 7B is an enlarged medium facing surface view of the writer of FIG. 7A when the write field of the write pole is positive.

FIG. 7C is an enlarged medium facing surface view of the writer of FIG. 7A when the write field of the write pole is negative.

FIG. 8A is a cross-sectional view of a writer containing a permanent magnet in the side shield and configured to produce additional magnetic field.

FIG. 8B, FIG. 8C and FIG. 8D are enlarged medium facing surface views of the writer of FIG. 8A when a write field of a write pole is zero, positive and negative, respectively.

FIG. 9A, FIG. 9B and FIG. 9C are enlarged medium facing surface views of a writer containing a permanent magnet in a trailing shield when a write field of a write pole is zero, positive and negative, respectively, and the permanent magnet is configured to reduce flux leakage.

FIG. 10A, FIG. 10B and FIG. 10C are enlarged medium facing surface views of a writer containing a permanent magnet in a trailing shield when a write field of a write pole is zero, positive and negative, respectively, and the permanent magnet is configured to produce additional write field.

FIG. 11 is an enlarged medium facing surface view of a writer containing a permanent magnet stack in a trailing shield.

### DETAILED DESCRIPTION

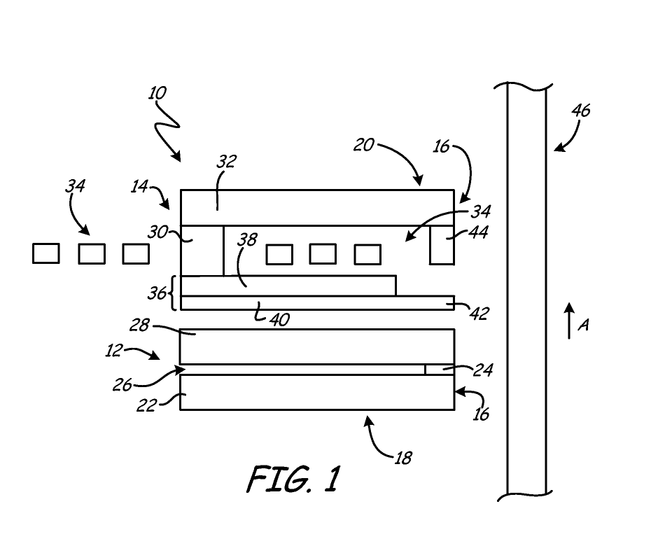

FIG. 1 is a cross-sectional view of recording head 10, which includes reader 12 and writer 14 that define medium confronting surface 16. Reader 12 and writer 14 each have medium confronting surface 16, leading edge 18 and trailing edge 20. Reader 12 includes bottom shield structure 22, read element 24, read gap 26, and top shield structure 28. Writer 14 includes magnetic stud 30, return pole 32, conductive coil 34, write pole 36 (having yoke 38, write pole body 40 and write pole tip 42) and trailing shield 44.

Reader 12 and writer 14 are shown merely for purposes of illustrating a construction that may be used in recording head 10 and variations on that design can be made. For example, writer 14 can have dual return poles instead of a single return pole design as shown. Writer 14 can also have dual coils.

On reader 12, read gap 26 is defined on medium confronting surface 16 between terminating ends of bottom shield 22 and top shield 28. Read element 24 is positioned in read gap 26 adjacent medium confronting surface 16. Read element 24 may be any variety of different types of read elements, such as a magnetoresistive (MR) element, a tunneling magnetoresistive (TMR) read element or a giant magnetoresistive (GMR) read element.

Recording head 10 confronts magnetic medium 46 at medium confronting surface 16, such as an air bearing surface (ABS). Magnetic medium 46 is positioned proximate to recording head 10. Reader 12 and writer 14 are carried over the surface of magnetic medium 46. Magnetic medium 46 is moved relative to recording head 10 as indicated by arrow A such that write pole 36 trails reader 12 and leads return pole 32.

Reader 12 reads data from magnetic medium 46. In operation, magnetic flux from a surface of magnetic medium 46 causes rotation of a magnetization vector of read element 24, which in turn causes a change in electrical resistivity of read element 24. The change in resistivity of read element 24 can be detected by passing a current through read element 24 and measuring a voltage across read element 24. Shields 22 and 28, which may be made of a soft ferromagnetic material, guide stray magnetic flux away from read element 24.

Write pole 36 is used to physically write data to magnetic medium 46. Magnetic stud 30 magnetically couples write pole 36 to return pole 32. Conductive coil 34 surrounds magnetic stud 30. Conductive coil 34 passes through the gap between write pole 36 and return pole 32. Return pole 32 and magnetic stud 30 can comprise soft magnetic materials, such as NiFe; conductive coil 34 can comprise a material with low electrical resistance, such as Cu; and write pole body 40 can comprise a high moment soft magnetic material, such as CoFe.

To write data to magnetic medium 46, current is caused to flow through conductive coil 34. The magnetomotive force in coil 34 causes magnetic flux from write pole tip 42 to travel through a closed magnetic flux path created by magnetic medium 46, return pole 32, magnetic stud 30 and write pole 36. The direction of the write field at medium confronting surface 16 of write pole tip 42 is controlled based on the direction of the current flow through conductive coil 34. The direction of the write field is related to the polarity of the data written to magnetic medium 46.

One method to improve the areal density of the recording media is to confine the magnetic field using shields. For example, to control the track width and achieve a sharp cross-track gradient, magnetic side shields are added on either side of the write pole. Additionally or alternatively, a trailing shield can be added to the write head. Such shields may reduce the magnetic field of the write pole. The shields also are a concern for adjacent track interference (ATI) as domains may form in these shields.

Trailing shield 44 is positioned at leading edge 18 of return pole 32 and is spaced apart from trailing edge 20 of write pole tip 42. Trailing shield 44 comprises a soft magnetic material. Trailing shield 44 forces flux from write pole 36 to return over a shorter path, which boosts the field gradient and writes sharper transitions on medium 46. The field gradient can be further improved by positioning trailing shield 44 closer to write pole 36. However, flux from write pole 36 increasingly prefers trailing shield 44 with decreasing distance between write pole 36 and trailing shield 44. If trailing shield 44 is too close to write pole 36, flux will leak from pole tip 42 to trailing shield 44 and reduce the write field. Further, positioning trailing shield 44 closer to write pole 36 will also increase the risk of erasure, especially the risk of down-track erasure, due to the high negative field gradient.

The following figures describe writer 14 having a permanent magnet incorporated into the structure. The permanent magnet is configured so that the magnetization orientation of the permanent magnet is switched using an exchange spring mechanism as a function of a change in direction of the write field of writer 14. The permanent magnet can be incorporated into writer 14 at various locations. In a first example, a permanent magnet is incorporated into write pole 36 and is configured to increase the electromagnetic field from write pole 36. In a second example, a permanent magnet is incorporated into soft magnetic side shields on either side of write pole 36. In the second example, the permanent magnets are configured to either increase the electromagnetic field from write pole 36 or to reduce the amount of flux leakage through the side shields. In a third example, a permanent magnet is incorporated into trailing shield 44. This permanent magnet is configured to either increase the electromagnetic field from write pole 36 or to reduce the amount of flux leakage through trailing shield 44. For convenience and clarity, the terms cross-track, down-track and perpendicular direction will be used to describe locations and positions on writer 14. These terms are determined with respect to the movement of writer 14 and are not intended to limit the applicability of the invention.

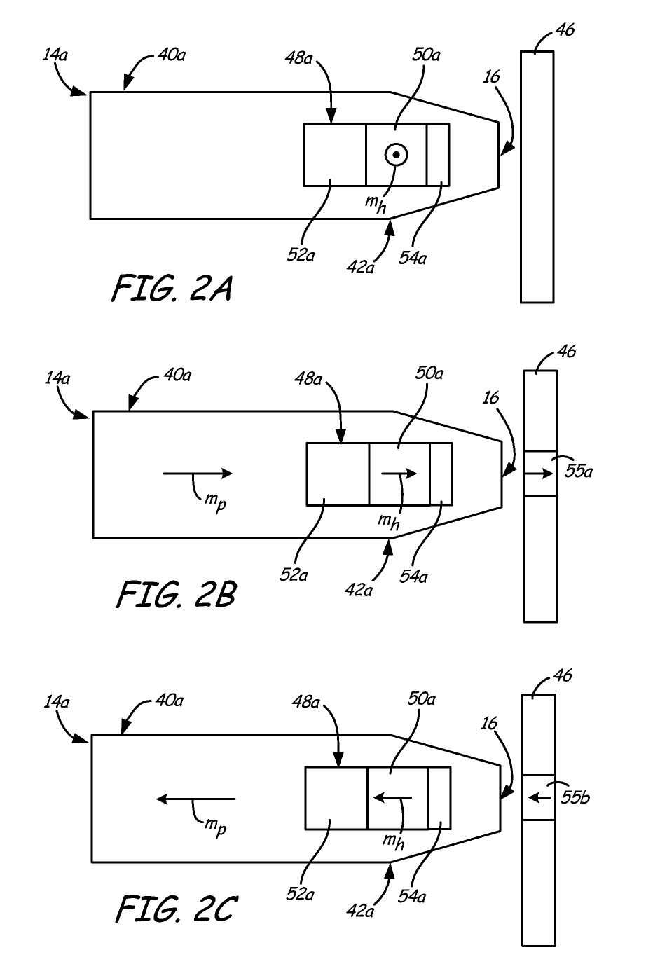

FIG. 2A is an enlarged cross-sectional view of writer 14a having zero write field. Writer 14a includes write pole body 40a, write pole tip 42a, stack 48a (including permanent magnet 50a, first soft magnet 52a and second soft magnet 54a). Stack 48a is incorporated into write pole body 40a near the breakpoint of write pole body 40a. In one example, stack 48a is about 30 nanometers from medium confronting surface 16 of write pole tip 42a.

First and second soft magnets 52a and 54a, respectively, are located on either perpendicular side of permanent magnet 50a, such that permanent magnet 50a is sandwiched between first and second soft magnets 52a and 54a. First soft magnet 52a is furthest from magnetic medium 46, second soft magnet 54a is closest to magnetic medium 46. Permanent magnet 50a is between soft magnets 52a and 54a.

Permanent magnet 50a is a hard magnet. Permanent magnet 50a has a magnetic anisotropic field (Hₖ) between about 20 kiloOersteds (kOe) and about 60 kOe, where Hₖ is determined by formula (I)

Hₖ=2Kᵤ/M_{S} (1)

and where Kᵤ is the uniaxial magnetic anisotropy constant and Mₛ is the saturation magnetization of the material. First and second soft magnets 52a and 54a have a magnetic anisotropic field between about 10 Oe and 3 kOe.

First and second soft magnets 52a and 54a can have a uniform anisotropy or can be graded. In one example, first and second soft magnets 52a and 54a are graded such that the anisotropy increases with decreasing distance to permanent magnet 50a. Such a configuration provides additional parameters that can be varied in order to tailor writer 14a.

Permanent magnet 50a has a higher magnetic anisotropic field value than write pole 40a. Because permanent magnet 50a has a high magnetic anisotropic field value than write pole 40a, it produces a more intense field. However, it is more difficult to switch magnetization orientation mₕ of permanent magnet 50a.

First and second soft magnets 52a and 54a are exchange coupled to permanent magnet 50a. Using exchange coupling, first and second soft magnets 52a and 54a are designed to assist in switching the orientation of the magnetization of permanent magnet 50a. In the presence of a write field, the magnetization of first and second soft magnets 52a and 54a rotate before the magnetization of permanent magnet 50a rotates. The rotation of first and second soft magnets 52a and 54a assists the rotation of the magnetization of permanent magnet 50a via an exchange spring mechanism. First and second soft magnets 52a and 54a and permanent magnet 50a are tuned to enable dynamic switching of stack 48a. The ratio of the magnetic anisotropy of first and second soft magnets 52a and 54a and permanent magnet 50a is tailored to achieve an effective exchange spring mechanism. The thicknesses of first and second soft magnets 52a and 54a and permanent magnet 50a can also be adjusted to achieve swift complete reversal of the magnetization of permanent magnet 50a.

Permanent magnet 50a is configured to assist the electromagnetic field from write pole body 40a. The magnetization of permanent magnet 50a is switched to produce field and to generate magnetic field in addition to the electromagnetic field from write pole body 40a. The magnetization of permanent magnet 50a is switched as a function of a change in direction of the write field of write pole body 40a. FIG. 2B illustrates write pole tip 42a having a positive field and forming positive portion 55a on magnetic medium 46; FIG. 2C illustrates write pole tip 42a having a negative field and forming negative portion 55b on magnetic medium 46. Arrow mₚ illustrates the polarity of (or direction of write field of) writer pole body 40a and arrow mₕ illustrates the magnetization orientation of permanent magnet 50a. As shown in FIG. 2B, when write pole body 40a has a positive field, magnetization orientation mₕ of permanent magnet 50a aligns with and has the same orientation as polarity mₚ of write pole body 40a. Similarly, as shown in FIG. 2C, when write pole body 40a has a negative field, magnetization orientation mₕ of permanent magnet 50a aligns with and has the same orientation as polarity mₚ of write pole body 40a. Permanent magnet 50a generates its own field. Writer 14a does not require additional energy to generate the additional field produced by permanent magnet 50a. By generating additional field in the same direction as write pole body 40a, permanent magnet 50a increases the write field achievable by writer 14a. The stronger field assists writer 14a during the write process and is particularly beneficial when writing to a high density recording medium 46 that has a high coercivity.

Precautions should be taken to mitigate against erasure when stack 48a is inserted into write pole body 40a. Magnetic media 46 that is switched or that is written to using perpendicular fields is highly sensitive to perpendicular field components. In one example when the field through write pole body 40a is zero, magnetization orientation mₕ of permanent magnet 50a is aligned along the cross-track direction to avoid erase after write, such that the field of permanent magnet 50a is directed away from media 46. Alternatively when write pole 40a has zero write field, magnetization orientation mₕ of permanent magnet 50a can be anti-parallel to (i.e. not aligned with) the perpendicular axis of writer 14a so that the field of permanent magnet 50a is directed away from magnetic media 46. Additional methods of mitigating against erasure not specifically mentioned here can also be used.

Although stack 48a is illustrated as containing first and second soft magnets 52a and 54a and permanent magnet 50a, stack 48a can contain permanent magnet 50a and only one of first and second soft magnets 52a and 54a. Additionally, permanent magnet 50a can be exchanged coupled to the soft magnetic material of write pole 36 instead of to first and second soft magnets 52a and 54a. In such a configuration, first and second soft magnets 52a and 54a are not present in writer 14a and soft magnetic material of write pole 36 assists in switching magnetization orientation mₕ of permanent magnet 50a.

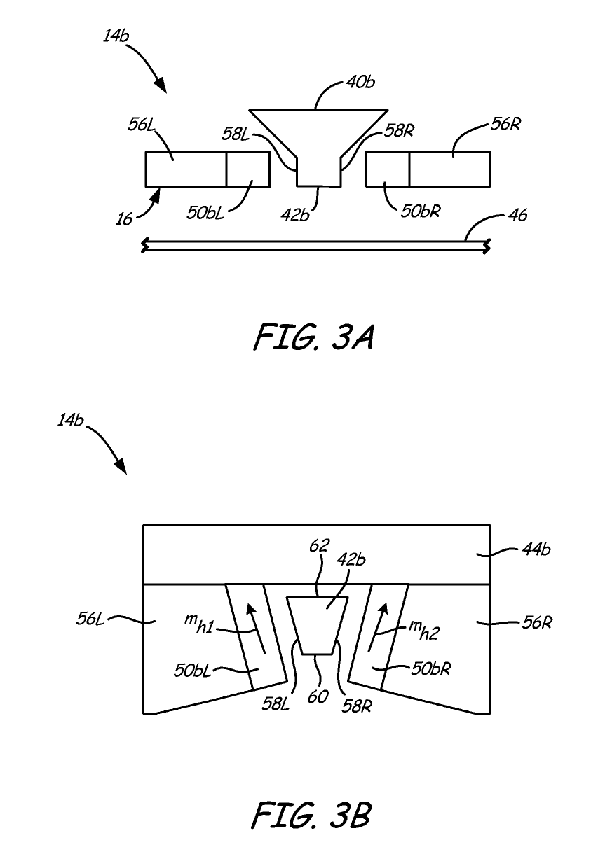

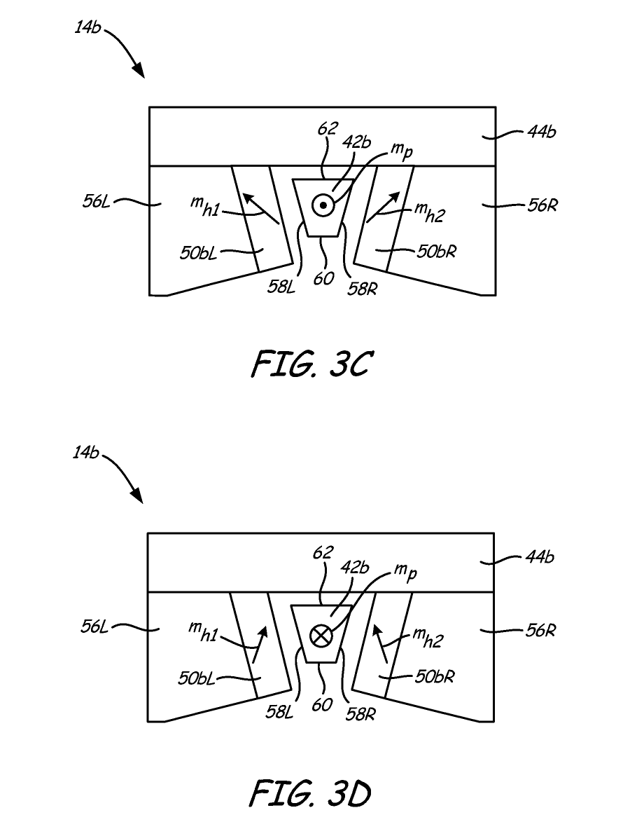

Permanent magnet 50 can also be incorporated in a side shield of writer 14. Magnetization orientation mₕ of these permanent magnets can be controlled as a function of a change in direction of the write field of write pole 36 (including write pole body 40 and write pole tip 42). FIG. 3A is a cross-sectional view of writer 14b having write pole 40b, first and second side shields 56L and 56R, respectively, and first and second permanent magnets 50bL and 50bR, respectively. First side shield 56L is located at first cross-track side 58L of write pole tip 42b, and second side shield 56R is located at second cross-track side 58R of write pole tip 42b. Side shields 56L and 56R face magnetic media 46 at a medium confronting surface 16.

First permanent magnet 50bL is adjacent first side shield 56L and is proximate first side 58L of write pole tip 42b. Similarly, second permanent magnet 50bR is adjacent second side shield 56R and is proximate second side 58L of write pole tip 42b. First and second permanent magnets 50bL and 50bR (collectively referred to as permanent magnets 50b) are closer to write pole tip 42b than first and second side shields 56L and 56R are to write pole tip 42b. Permanent magnets 50a have a magnetic anisotropic field (Hₖ) between about 20 kOe and about 60 kOe. First and second side shields 56L and 56R comprise a soft magnet having a magnetic anisotropic field between about 10 Oe and 3 kOe.

For clarity, first side shield 56L and first permanent magnet 50bL will be described. Second side shield 56R and second permanent magnet 50bR have a similar configuration. First permanent magnet 50bL is exchange coupled to first side shield 56L. First side shield 56L assists in switching the magnetization orientation of first permanent magnet 50bL using an exchange spring mechanism. As described further below, the magnetization orientation of first permanent magnet 50bL in writer 14b oscillates; the magnetization orientation of first permanent magnet 50bL does not necessarily completely switch (i.e. the magnetization orientation of first permanent magnet 50bL when write pole tip 42b has a positive field is less than 180 degrees from the magnetization orientation of first permanent magnet 50bL when write pole tip 42b has a negative field).

The orientation of the magnetization of first permanent magnet 50bL is controlled using an exchange spring mechanism to minimize flux leakage to side shield 56L. Flux leakage normally occurs through side shield 56L because of the permeability of side shield 56L. As the permeability of side shield 56L increases, the flux leakage also increases. The higher anisotropy of first permanent magnet 50bL reduces the flux leakage from write pole tip 42b to side shield 56L. The magnetization orientation of first permanent magnet 50bL is controlled as a function of the change in direction of the write field of write pole tip 42b as described further below with respect to FIGS. 3B, 3C and 3D.

The orientation of the magnetization of first permanent magnet 50bL is also controlled to minimize domain formation in first side shield 56L. Domains can occur in soft shields, such as first side shield 56L, and agglomerate in certain areas driven by the structural shape and geometry of the shield. For example in first side shield 56L, strong perpendicular domains can occur near the edges opposite to write pole tip 42b and at the corners. Domains result in stray, uncontrolled fields and increase the risk of erasure. The higher anisotropy of first permanent magnet 50bL assists in maintaining a consistent magnetization orientation in first side shield 56L. First permanent magnet 50bL decreases the formation of domains and domain walls and reduces the risk of erasure.

FIGS. 3B, 3C and 3D are enlarged medium facing surface views of writer 14b of FIG. 3A illustrating the magnetization orientation mₕ of permanent magnets 50bL and 50bR when write pole tip 42b has zero write field, a positive write field and a negative write field, respectively. A medium facing surface view means the view of the writer taken from the perspective of medium 46. Write pole tip 42b includes first side 58L and second side 58R in the cross-track direction and leading edge 60 and trailing edge 62 in the down-track direction. Trailing shield 44b can be present down-track of trailing edge 62.

FIG. 3B shows magnetization orientation mₕ₁ of first permanent magnet 50bL adjacent first side shield 56L and magnetization orientation mₕ₂ of second permanent magnet 50bR adjacent second side shield 56R when writer 14b is at a zero field state. When write pole tip 42b has zero write field, magnetization orientations mₕ₁ and mₕ₂ are directed in the down-track direction. That is, magnetization orientation mₕ₁ and mₕ₂ are about parallel to first and second sides 58L and 58R of write pole tip 42b. This magnetization orientation of first and second permanent magnets 50bL and 50bR reduces the risk of erase after write.

FIG. 3C illustrates magnetization orientation mₕ₁ of first permanent magnet 50bL, magnetization orientation mₕ₂ of second permanent magnet 50bR and orientation mₚ of the write field generated by write pole tip 42b when writer 14b has a positive polarity or a positive write field. Similarly, FIG. 3D illustrates magnetization orientation mₕ₁ and mₕ₂ and orientation mₚ when writer 14b has a negative write field. Magnetization orientations mₕ₁ and mₕ₂ oscillate around a down-track axis. This is known as canting. Magnetization orientations mₕ₁ and mₕ₂ are symmetric and are a mirror image of one another. When writer 14b has a positive field, magnetization orientations mₕ₁ and mₕ₂ are directed generally away from write pole tip 42b. When writer 14b has a negative field, magnetization orientations mₕ₁ and mₕ₂ are directed generally towards write pole tip 42b.

In writer 14b, permanent magnets 50b are configured to reduce flux leakage to side shields 56; permanent magnets 50b are not configured to produce additional field. Thus, magnetization orientations mₕ₁ and mₕ₂ are not required to fully switch in writer 14b. For example, there is less than a 180 degree difference in magnetization orientation mₕ₁ when write pole 42b has a positive field and a negative field. As described above, magnetization orientations mₕ₁ and mₕ₂ are controlled as a function of the direction of the write field of write pole tip 42b. Magnetization orientations mₕ₁ and mₕ₂ oscillate depending on the direction of the write field. Although FIG. 3B illustrates a specific magnetization of permanent magnets 50bL and 50bR when write pole tip 42b has a zero write field, permanent magnets 50bL and 50bR can have any magnetization orientation that does not present a significant risk of erase after write.

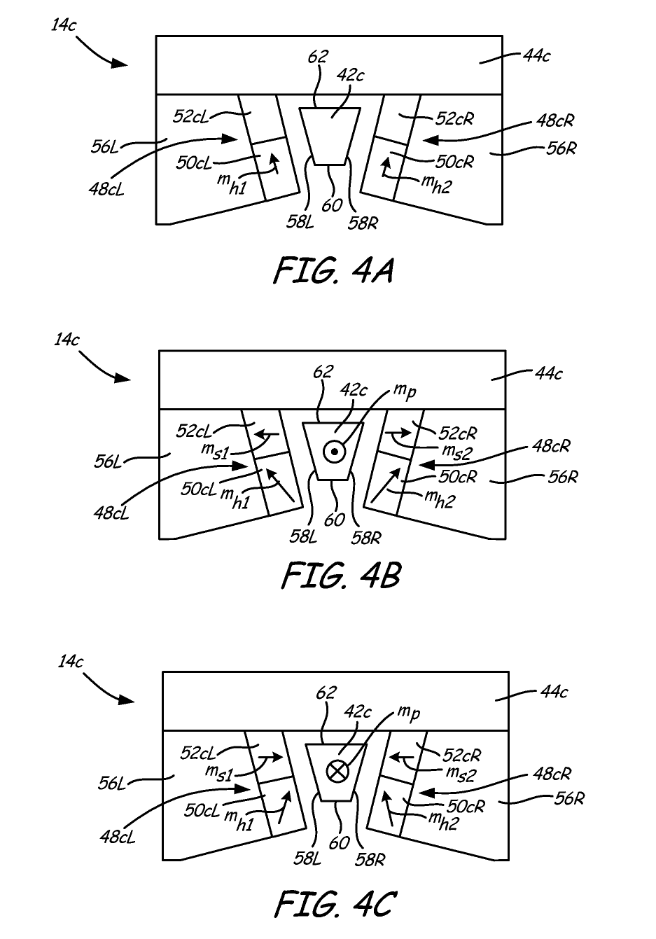

FIG. 4A is an enlarged medium facing surface view of an alternative example of writer 14c having first and second permanent magnets 50cL and 50cR adjacent first and second side shields 56L and 56R. Writer 14c includes write pole tip 42c (having first side 58L, second side 58R, leading edge 60 and trailing edge 62), first and second side shields 56L and 56R, respectively, first stack 48cL (including first permanent magnet 50cL and first soft magnet 52cL), second stack 48cR (including second permanent magnet 50cR and second soft magnet 52cR) and trailing shield 44c. First side shield 56L is located at first side 58L of write pole tip 42c, second side shield 56R is located at second side 58R of write pole tip 42c and trailing shield 44c is located at trailing edge 62 of write pole tip 42c. First and second stacks 48cL and 48cR are down-track oriented two-layer permanent magnet stacks. First permanent magnet 50cL and first soft magnet 52cL are positioned between first side 58L of write pole tip 42c and first side shield 56L. First permanent magnet 50cL and first soft magnet 52cL are closer to write pole tip 42c than first side shield 56L is to write pole tip 42c. Second permanent magnet 50cR and second soft magnet 52cR have a similar configuration. For simplicity, only first permanent magnet 50cL and first soft magnet 52cL at first side 56L of write pole tip 42c will be described.

In writer 14c, first permanent magnet 50cL and first soft magnet 52cL are located in a cross-track direction between first side shield 56L and first side 58L of write pole tip 42c. First permanent magnet 50cL is adjacent to first soft magnet 52cL in the down-track direction along the length of first side shield 56L of write pole tip 42c. First permanent magnet 50cL and first soft magnet 52cL are arranged so that first soft magnet 52cL is closer to trailing shield 44c than first permanent magnet 50cL is to trailing shield 44c. First permanent magnet 50cL has a high anisotropic field and first soft magnet 52cL has a low anisotropic field as described above. In one example, first permanent magnet 50cL has a magnetic anisotropic field (Hₖ) between about 20 kOe and about 60 kOe, and first soft magnet 52cL has a magnetic anisotropic field between about 10 Oe and 3 kOe.

Soft magnet 52cL can have a constant anisotropic field or can be graded. A graded soft magnet 52cL can be formed by layering materials having different anisotropic fields. In one example, soft magnet 52cL contains a plurality of material layers that are arranged so that the anisotropic field of soft magnet 52cL increases with decreasing distance to first permanent magnet 50cL.

First permanent magnet 50cL is exchanged coupled to first soft magnet 52cL. Soft magnet 52cL assists in switching magnetization orientation mₕ₁ of first permanent magnet 50cL with a spring coupling mechanism. First permanent magnet 50cL and soft magnet 52cL are tailored to enable canting of first permanent magnet 50cL, such that the magnetization orientation of first permanent magnet 50cL oscillates but does not necessarily fully switch. Tailoring permanent magnet 50cL and soft magnet 52cL can include changing the anisotropy ratio and changing the thickness ratio of permanent magnet 50cL and soft magnet 52cL. Grading soft magnet 52cL provides additional tailoring factors.

Magnetization orientation mₕ₁ of first permanent magnet 50cL is switched as a function of a change in a direction of the write field of write pole 36c and write pole tip 42c. In the zero field state shown in FIG. 4A, magnetization orientations mₕ₁ and mₕ₂ of first and second permanent magnets 50cL and 50cR, respectively, are directed down-track to reduce the risk of erasure. That is, when write pole tip 42c has a zero write field, magnetization orientations mₕ₁ and mₕ₂ are about parallel to first and second sides 58L and 58R of write pole tip 42c and are directed towards trailing shield 44a. Magnetization orientations mₕ₁ and mₕ₂ oscillate as a function of a change in direction of the write field of write pole tip 42c as illustrated in FIGS. 4B and 4C. Permanent magnets 50cL and 50cR oscillate similar to permanent magnets 50bL and 50bR of writer 14b in FIGS. 3C and 3D.

Magnetization orientations mₛ₁ and mₛ₂ of soft magnets 52cL and 52cR also change as a function of the direction of the write field of write pole tip 42c as illustrated in FIGS. 4B and 4C. When write pole tip 42c has a positive field, mₛ₁ and mₛ₂ are oriented away from write pole 42c in the cross-track direction. When write pole 42c has a negative field, mₛ₁ and mₛ₂ are oriented towards write pole tip 42c in the cross-track direction. As shown, magnetization orientations mₛ₁ and mₛ₂ of soft magnets 52cL and 52cR fully switch with the changing write field, such that there is about a 180 degree difference between magnetization orientation mₛ₁ when the write field of write pole 42c is positive and when the write field is negative.

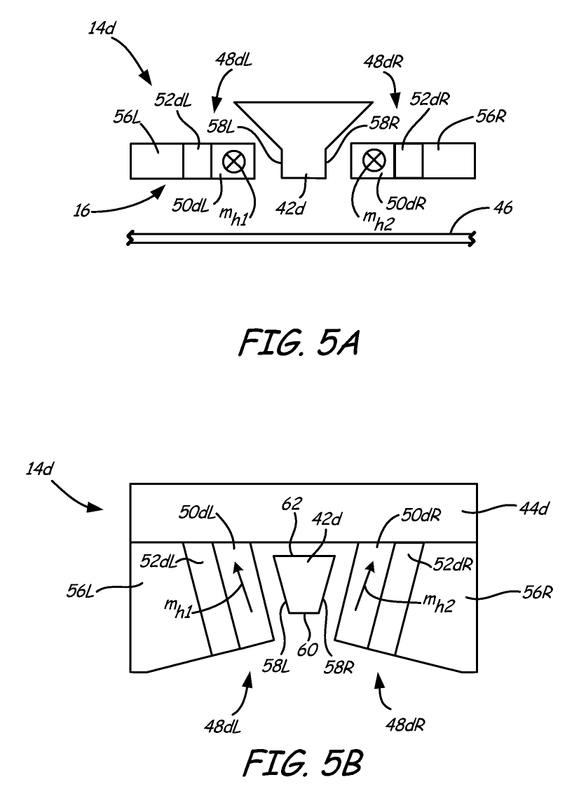

FIG. 5A is a cross-sectional view of another example writer 14d containing first and second permanent magnets 50dL and 50dR and first soft magnets 52dL and 52dR in side shields 56L and 56R, and FIG. 5B is an enlarged medium facing surface view of writer 14d where write pole tip 42d has a zero write field. First stack 48dL, which includes first permanent magnet 50dL and first soft magnet 52dL, is a cross-track oriented two-layer permanent magnet stack. In writer 14d, soft magnet 52dL is positioned between first permanent magnet 50dL and first side shield 58L. First permanent magnet 50dL is closer to write pole tip 42d than soft magnet 50dL is to write pole tip 42d. Second stack 48dR, which includes second permanent magnet 50dR and second soft magnet 52dR, has a similar configuration.

Soft magnets 52dL and 52dL and permanent magnets 50dL and 50dR are the same as those described above. Soft magnets 52dL and 52dR can have a constant anisotropic field or can be graded. Further, magnetization orientation mₕ₁ and mₕ₂ of permanent magnets 50dL and 50dR are directed downstream in the zero field state and oscillate using an exchange spring mechanism as described above for writer 14b and 14c.

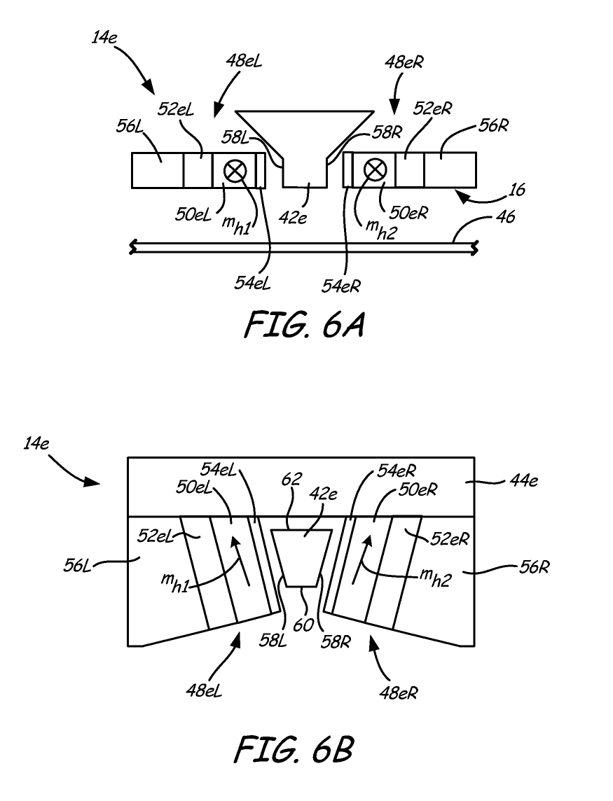

FIG. 6A is a cross-sectional view of a further example writer 14e containing first and second permanent magnets 50eL and 50eR in side shields 56L and 56R when write pole tip 42e has a write field of zero. FIG. 6B is an enlarged medium facing surface view of writer 14e when write pole tip 42e has a write field of zero. Writer 14e includes write pole tip 42e, first and second side shield 58L and 58R, respectively, first stack 48eL (which includes first soft magnet 52eL, first permanent magnet 50eL and second soft magnet 54eL) and second stack 48eR (which includes first soft magnet 52eR, second permanent magnet 50eR and second soft magnet 54eR). First stack 48eL is positioned between first side 58L of write pole tip 42e and first side shield 56L, and a second stack 48eR is positioned between second side 58R of write pole tip 42e and second side shield 56R. For clarity, first stack 48eL, which is positioned between first side 58L of write pole tip 42 and first side shield 56L, will be described. Second stack 48eR, which is positioned between second side 58R of write pole tip 42 and second side shield 56R, has a similar configuration and functions in a similar manner as first stack 48eL.

First stack 48eL is a cross-track oriented three-layer permanent magnet stack. First stack 48eL has a sandwich configuration. First permanent magnet 50eL is positioned between first soft magnet 52eL and second soft magnet 54eL. First and second soft magnets 52eL and 54eL, respectively, are exchanged coupled to first permanent magnet 50eL to assist in switching the magnetization orientation of first permanent magnet 50eL. As described above, first permanent magnet 50eL has a high anisotropic field and first and second soft magnets 52eL and 54eL have low anisotropic fields. The anisotropic field ratio of permanent magnet 50eL and first and second soft magnets 52eL and 54eL are tailored to enable a spring coupling mechanism to assist in switching the magnetization orientation of permanent magnet 50eL.

As shown in FIG. 6B, when write pole tip 42e has zero write field, magnetization orientation mₕ₁ and mₕ₂ of permanent magnets 50eL and 50eR are in the down-track direction towards trailing shield 44e to reduce the risk of erasure. Magnetization orientations mₕ₁ and mₕ₂ of permanent magnets 50eL and 50eR are oscillated similar to permanent magnets 50bL and 50bR of writer 14b in FIGS. 3B-3D. Magnetization orientations mₕ₁ and mₕ₂ of permanent magnets 50eL and 50eR are changed as a function of a change in direction of the write field of write pole tip 42e. The sandwich configuration of stacks 48eL and 48eR can result in improved oscillating of permanent magnets 50eL and 50eR.

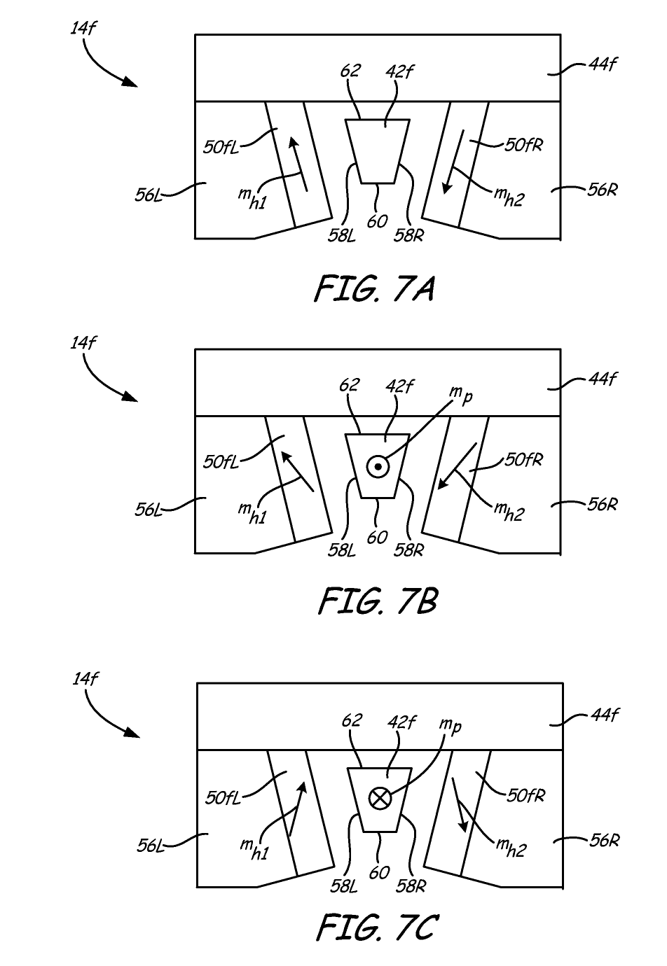

FIGS. 7A, 7B and 7C are enlarged medium facing surface views of an alternative example of writer 14f. Writer 14f is similar to writer 14b of FIG. 3B except magnetization orientations mₕ₁ and mₕ₂ of permanent magnets 50f are asymmetric. FIG. 7A illustrates writer 14f in a zero field state, FIG. 7B illustrates writer 14f in a positive field state and FIG. 7C illustrates writer 14f in a negative field state. Magnetization orientations mₕ₁ and mₕ₂ are oscillated when the field in writer 14f changes to maintain the asymmetric configuration. When magnetization orientation mₕ₁ is oscillated towards write pole tip 42f, magnetization orientations mₕ₂ is oscillated away from write pole tip 42f. The asymmetric configuration of writer 14f further minimizes the formation of domains in first and second side shields 56L and 56R.

Writers 14b, 14c, 14d, 14e and 14f contain permanent magnets proximate first and second sides 58L and 59R of write pole tip 42. The magnetization orientation of the permanent magnet is changed as a function of a change in direction of the write field of write pole 36. In writers 14b, 14c, 14d, 14e and 14f, the magnetization orientation of permanent magnets 50bL, 50bR, 50cL, 50cR, 50dL, 50dR, 50eL, 50eR, 50fL and 50fR (collectively permanent magnets 50) oscillate (also known as canting); the magnetization of permanent magnets 50 is not required to switch 180 degrees between their orientation when write pole tip 42 has a positive field and when write pole tip 42 has a negative field. Writers 14b, 14c, 14d, 14e and 14f have reduced the flux leakage through side shields 56L and 56R and reduced formation of domains in side shields 56L and 56R. The strong anisotropy of permanent magnet 50 controls domains and prevents domains from concentrating due to the shape or geometry of side shields 56L and 56R. Additionally, the magnetization orientations of permanent magnets 50 are configured to reduce the risk of erasure when write pole tip 42 has a zero write field.

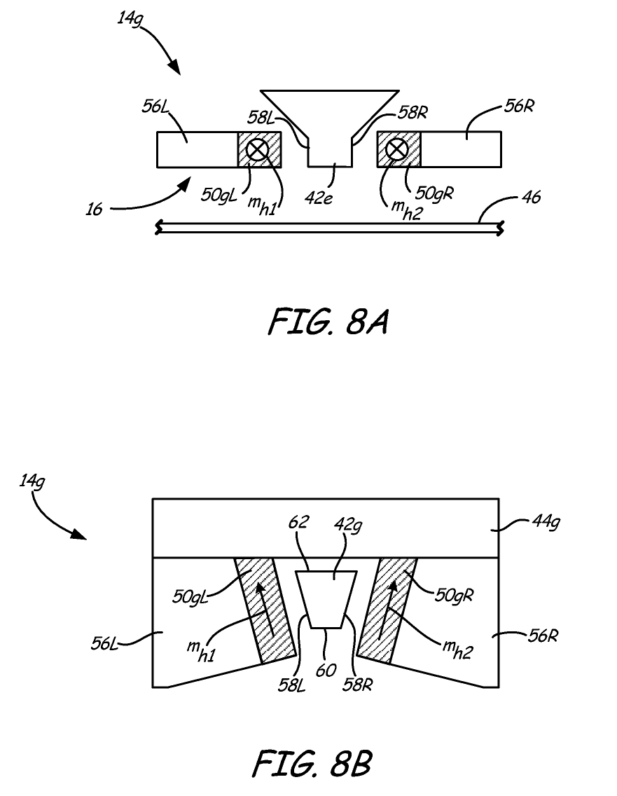

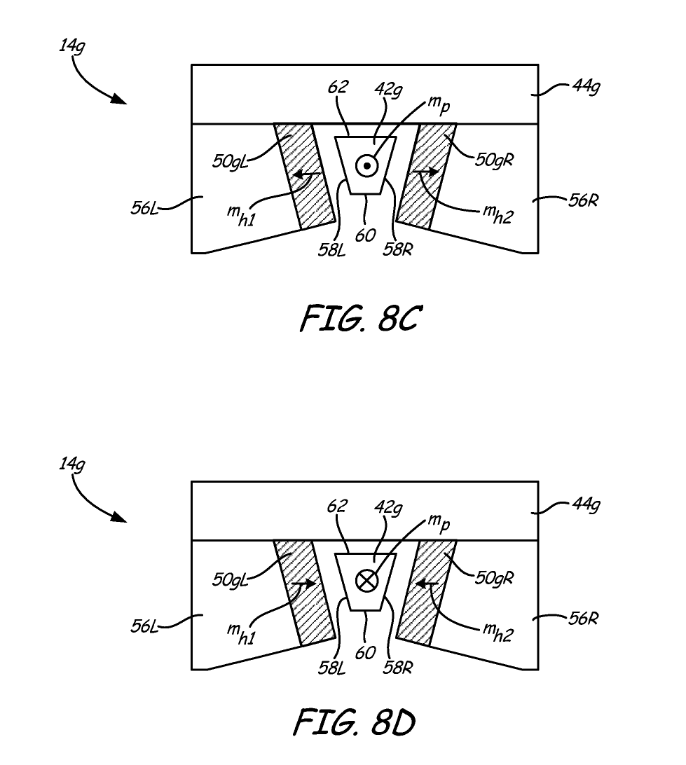

FIG. 8A is a cross-sectional view of writer 14g, which is configured to produce additional magnetic field, and FIG. 8B is an enlarged medium facing surface view of writer 14g when there is zero field in write pole tip 42g. Writer 14g includes write pole body 40g, write pole tip 42g (having leading edge 60, trailing edge 62, first side 58L and second side 58R), first and second side shields 56L and 56R, trailing shield 44g, first permanent magnet 50gL and second permanent magnet 50gR. First permanent magnet 50gL is exchange coupled to the soft magnetic material of first side shields 56L to create an exchange composite coupling (ECC) stack. Second permanent magnet 50fR and second side shield 56R have a similar configuration. Writer 14g differs from writer 14b of FIG. 3A in the configuration of permanent magnets 50g. In writer 14g, first and second permanent magnets 50gL and 50gR are configured to produce additional magnetic field, and the magnetization orientation of first and second permanent magnets 50gL and 50gR is changed as a function of a change in direction of the write field of write pole 36 and write pole tip 42g, as described further below.

When there is zero field in write pole tip 42g, the magnetization orientation of first and second permanent magnets 50gL and 50gR is in the down-track direction towards trailing shield 44g. With zero field in write pole tip 42g, writer 14g is configured such that the magnetization of permanent magnets 50gL and 50gR is perpendicular to trailing shield 44g and parallel with first and second side shields 56L and 56R. Aligning the magnetization of permanent magnets 50gL and 50gR in the down-track direction when there is zero field in write pole tip 42g reduces the risk of erase after write. However, permanent magnets 50gL and 50gR can have a different magnetization orientation depending on the anisotropy of permanent magnets 50gL and 50gR and other parameters. Permanent magnets 50gL and 50gR are configured so that the magnetization of permanent magnets 50gL and 50gR switch direction as a function of the switching of write pole tip 42g.

FIG. 8C is an enlarged medium facing surface view of writer 14g when there is a positive field in write pole tip 42g, FIG. 8D is an enlarged medium facing surface view of writer 14g when there is a negative field in write pole tip 42g. Magnetization orientation mₕ₁ and mₕ₂ of permanent magnets 50gL and 50gR oppose the magnetic flux of first and second side shields 56L and 56R when there is a positive field or a negative field in write pole tip 42g. When there is a positive field in write pole tip 42g, magnetization orientations mₕ₁ and mₕ₂ of permanent magnets 50gL and 50gR lay in the cross-track direction and are directed away from write pole tip 42g. When there is a negative field in write pole tip 42g, magnetization orientations mₕ₁ and mₕ₂ of permanent magnets 50gL and 50gR lay in the cross-track direction and are directed towards write pole tip 42g. Magnetization orientations mₕ₁ and mₕ₂ fully switch to follow the switching of write pole tip 42g. That is, there is a 180 degree difference between mₕ₁ when write pole tip 42g has a positive field and mₕ₁ when write pole tip 42g has a negative tip. By switching magnetization orientations, permanent magnets 50gL and 50gR increase the amplitude for the positive and negative field. As writer 14g is energized, permanent magnets 50gL and 50gR switch and generate additional field. Although writer 14g has been described has having a cross-track oriented two-layer configuration, writer 14g can have any configuration, such as the down-track oriented two-layer configuration described with respect to FIG. 4A or the cross-track oriented three-layer configuration described with respect to FIG. 6A.

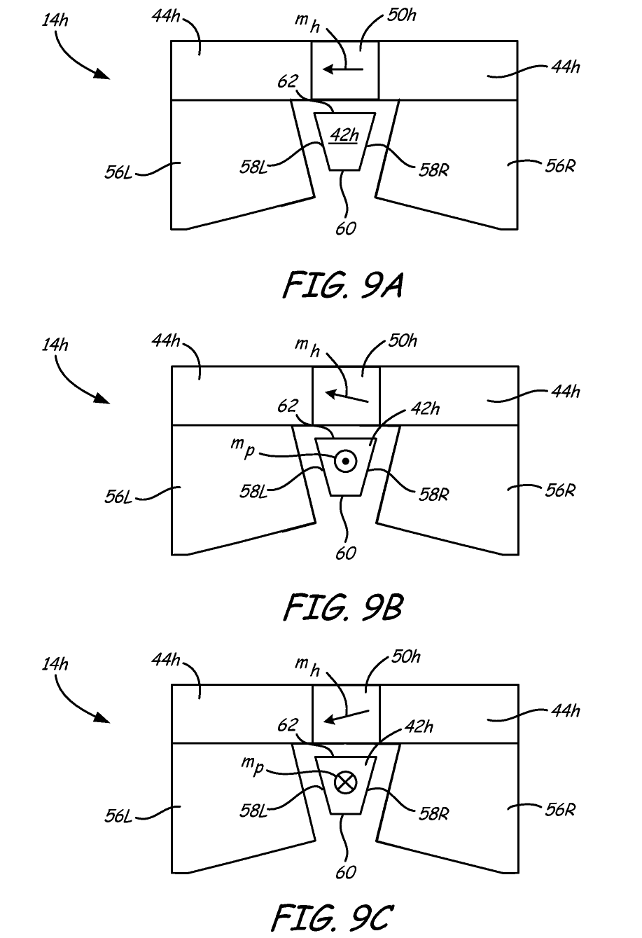

Permanent magnet 50h can alternatively or additionally be located in trailing shield 44h as shown in FIGS. 9A-9C. FIG. 9A is an enlarged medium facing surface view of writer 14h when write pole tip 42h has a zero field. Writer 14h includes trailing shield 44h, permanent magnet 50h, write pole tip 42h and first and second side shields 56L and 56R, respectively. Trailing shield 44h is proximate and spaced apart from trailing edge 62 of write pole tip 42h. Permanent magnet 50h is located in trailing shield 44h such that permanent magnet 50h is proximate and spaced apart from trailing edge 62 of write pole tip 42h. In one example, the width of permanent magnet 50h equals the width of trailing edge 62 of write pole tip 42h, where width is the measurement in the cross-track direction. In one example, magnetization orientation mₕ of permanent magnet 50h is oriented in the cross-track direction when there is zero field in write pole tip 42h to reduce or prevent erase after write.

Magnetic orientation mₕ₁ of permanent magnet 50h is changed as a function of a change in direction of the write field of write pole 36. Magnetic orientation mₕ of permanent magnet 50h is configured to oscillate as a function of the field in write pole tip 42h. FIG. 9B is an enlarged medium facing surface view of writer 14h when write pole tip 42h has a positive field and FIG. 9C is an enlarged medium facing surface view of writer 14h when write pole 42h has a negative field. Magnetization orientation mₕ of permanent magnet 50h oscillates according to the polarity of write pole 42h. When write pole tip 42h has a positive field, magnetization orientation mₕ of permanent magnet 50h oscillates in the positive down-track direction. When write pole tip 42 has a negative field, magnetization orientation mₕ of permanent magnet 50h oscillates in the negative down-track direction.

Permanent magnet 50h minimizes field amplitude reduction as flux leaks through the soft magnetic (i.e. low anisotropy) trailing shield 44h. Permanent magnet 50h also increases the cross-track gradient.

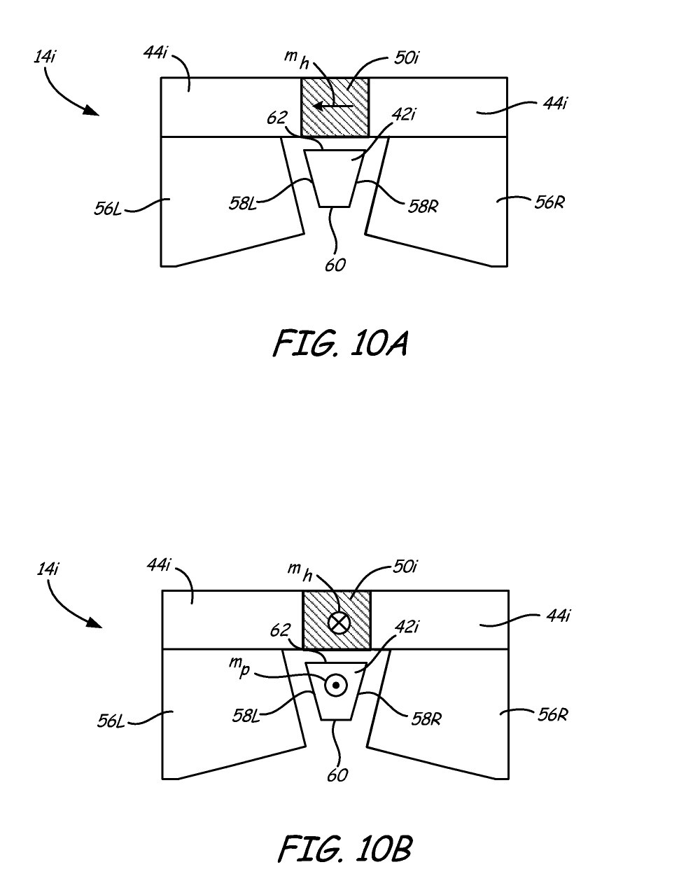

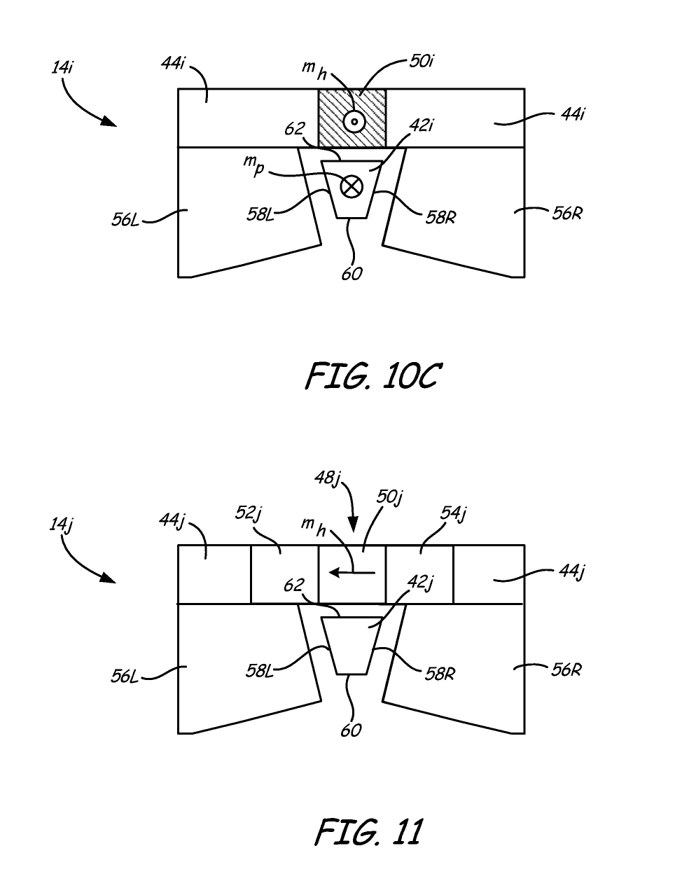

Alternatively, permanent magnet 50 located in trailing shield 44 can be configured to create additional field and assist write pole tip 42. FIGS. 10A, 10B and 10C are an enlarged medium facing surface views of writer 14i when write pole tip 42i has a zero field, positive field and negative field, respectively. Magnetization orientation mₕ of permanent magnet 50i changed as a function of a change in direction of the write field of write pole tip 42i. As shown in FIG. 10A, magnetization orientation mₕ of permanent magnet 50i is oriented in the downtrack direction when there is zero field in write pole tip 42i. When there is a positive field in write pole tip 42i, magnetization orientation mₕ of permanent magnet 50i is in the negative perpendicular direction such that magnetization orientation mₕ of permanent magnet 50i is opposite the magnetization orientation of write pole tip 42i, as shown in FIG. 10B. Finally, as shown in FIG. 10C, when there is a negative field in write pole tip 42i, magnetization orientation mₕ of permanent magnet 50i is in the positive perpendicular direction such that magnetization orientation mₕ of permanent magnet 50i is opposite the magnetization orientation of write pole tip 42i. When write pole tip 42i has a non-zero field, magnetization orientation mₕ of permanent magnet 50i is opposite the magnetization orientation of write pole tip 42i.

Magnetization orientation mₕ of permanent magnet 50i switches based on the polarity of write pole tip 42i. As described above, magnetization orientation mₕ of permanent magnet 50i switches 180 degrees from when write pole tip 42i has a positive field and when write pole tip 42i has a negative field. By fully switching, permanent magnet 50i produces additional field that assists write pole tip 42i during the write process and enables write pole tip 42i to write to medium 46 having a higher coercivity.

Low anisotropic material can be used to assist switching of permanent magnet 50. FIG. 11 is an enlarged medium facing surface view of writer 14j when write pole tip 42j has a zero field. As shown in FIG. 11, first and second soft magnets 52j and 54j can be placed on either cross-track side of permanent magnet 50j such that permanent magnet 50j has a sandwich configuration. First soft magnet 52j, permanent magnet 50j and second soft magnet 54j form permanent magnet stack 48j. Permanent magnet stack 48j extends the length of trailing edge 62j of write pole tip 42j, and first soft magnet 52j, permanent magnet 50j and second soft magnet 54j are about an equal distance from trailing edge 62j.

Similar to permanent magnet 50i, magnetization orientation mₕ of permanent magnet 50j is changed as a function of a change in direction of the write field of write pole tip 42. Magnetization orientation mₕ of permanent magnet 50j is configured to be directed in the cross-track direction when there write pole tip 42j has zero write field and is configured to be directed in the opposite direction as the magnetization of write pole tip 42j when write pole tip 42j has a positive and a negative field.

Permanent magnet 50j has a magnetic anisotropic field (Hₖ) between about 20 kiloOersteds (kOe) and about 60 kOe, and first and second soft magnets 52j and 54j have a magnetic anisotropic field between about 10 Oe and 3 kOe. First and second soft magnets 52j and 54j are exchange coupled to permanent magnet 50j. First and second soft magnets 52j and 54j and permanent magnet 50a are tuned to enable dynamic switching of permanent magnet 50j. The ratio of the magnetic anisotropy of first and second soft magnets 52j and 54j and permanent magnet 50j is tailored to achieve an effective exchange spring mechanism. The thicknesses of first and second soft magnets 52j and 54j and permanent magnet 50j can also be configured to achieve complete swift reversal of the magnetization of permanent magnet 50j. In one example, first and second soft magnets 52j and 54j have a uniform composition. In another example, first and second soft magnets 52j and 54j have a graded composition. In a further example, first and second soft magnets 52j and 54j are graded such that the anisotropic value of first and second soft magnets 52j and 54j increases with decreasing distance to permanent magnet 50j.

While the invention has been described with reference to an exemplary embodiment(s), it will be understood by those skilled in the art that various changes may be made and equivalents may be substituted for elements thereof without departing from the scope of the invention. For example, the magnetization orientations are presented as illustration only. Permanent magnets and/or soft magnets can have different magnetization orientations without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An apparatus comprising:
a write pole having a write pole tip, a leading edge, a trailing edge, a first side and a second side; and
a first permanent magnet located at the trailing edge, the first side or the second side of the write pole, the first permanent magnet having a magnetization orientation that is changed in relation to a field of the write pole.

2. The apparatus of claim 1, and further comprising:
a first low anisotropy magnet with a magnetic anisotropic field between about 10 Oersteds and about 3 kiloOersteds, wherein the first permanent magnet has a magnetic anisotropic field between about 20 kiloOersteds and about 60 kiloOersteds and the first permanent magnet is positioned adjacent the first low anisotropy magnet.

3. The apparatus of claim 2, wherein the first low anisotropy magnet is graded.

4. The apparatus of claim 1, and further comprising:
a first side shield;
a second side shield; and
a second permanent magnet, wherein the first permanent magnet is positioned between the first side shield and the first side of the write pole, and the second permanent magnet is positioned between the second side shield and the second side of the write pole.

5. The apparatus of claim 4, and further comprising:
a first low anisotropy magnet positioned between the first permanent magnet and the first side shield; and
a second low anisotropy portion magnet positioned between the second permanent magnet and the second side shield.

6. The apparatus of claim 5, and further comprising:
a third low anisotropy magnet positioned between the first side of the write pole and the first permanent magnet; and
a fourth low anisotropy magnet positioned between the second side of the write pole and the second permanent magnet.

7. The apparatus of claim 4, and further comprising:
a first low anisotropy magnet positioned adjacent a trailing edge of the first permanent magnet; and
a second low anisotropy magnet positioned adjacent a trailing edge of the second permanent magnet.

8. The apparatus of claim 4, wherein a magnetization of the first permanent magnet and a magnetization of the second permanent magnet are asymmetric.

9. The apparatus of claim 4, wherein the magnetization orientation of the first permanent magnet is configured to oscillate in relation to the field of the write pole.

10. The apparatus of claim 4, wherein the magnetization orientation of the first permanent magnet is configured to fully switch in relation to the field of the write pole.

11. The apparatus of claim 1, and further comprising a trailing shield at the trailing edge of the write pole, wherein the first permanent magnet is located in the trailing shield.

12. The apparatus of claim 11, and further comprising:
a first soft magnet on a first side of the first permanent magnet in the trailing shield; and
a second soft magnet on a second side of the first permanent magnet in the trailing shield.

13. The apparatus of claim 11, wherein the magnetization orientation of the first permanent magnet is opposite a magnetic orientation of the write pole tip when the write pole tip has a non-zero field.

14. A magnetic recording head comprising:
a write pole having a write pole tip, a leading edge, a trailing edge, a first side and a second side;
a trailing shield along the trailing edge of the write pole;
a first side shield along the first side of the write pole;
a second side shield along the second side of the write pole; and
a first permanent magnet configured to change magnetization orientation in response to a change in field in the write pole and positioned in the trailing shield, the first side shield or the second side shield.

15. The magnetic recording head of claim 14, and further comprising a first soft magnet having a low anisotropy and exchange coupled to the first permanent magnet.

16. The magnetic recording head of claim 15, and further comprising a second soft magnet having a low anisotropy and exchange coupled to the first permanent magnet.

17. The magnetic recording head of claim 14, wherein the first permanent magnet is located in the first side shield and has a magnetization orientation substantially parallel to the first side of the write pole when there is zero field in the write pole, and further comprising:
a second permanent magnet located in the second side shield and having a magnetization orientation substantially parallel to the second side of the write pole when there is zero field in the write pole.

18. The magnetic recording head of claim 14, wherein the first permanent magnet is located in the trailing shield and has a magnetization orientation substantially parallel to the trailing edge of the write pole when there is zero field in the write pole.

19. A method comprising:
generating write field in a write pole; and
changing a magnetization orientation of a permanent magnet located near the write pole and spaced from the magnetic medium as a function of a change in a direction of the write field of the write pole.

20. The method of claim 19, and further comprising fully switching the magnetization orientation of the permanent magnet to supplement the write field of the write pole.
